(19) United States
(12) Patent Application Publication
(10) Pub. No.: US 2024/0083533 A1
(43) Pub. Date: Mar. 14, 2024

(54) RACK ADAPTER FOR BICYCLE FENDERS

(71) Applicant: Yakima Products, Inc., Lake Oswego, OR (US)

(72) Inventors: Chris Sautter, Portland, OR (US); Charles Kraeuter, Portland, OR (US); Jason Attfield Sagen, Portland, OR (US); Craig DeAmbrose, Portland, OR (US)

(73) Assignee: Yakima Products, Inc., Lake Oswego, OR (US)

(21) Appl. No.: 18/452,489

(22) Filed: Aug. 18, 2023

Related U.S. Application Data
(63) Continuation of application No. 17/956,595, filed on Sep. 29, 2022, now abandoned.
(60) Provisional application No. 63/250,458, filed on Sep. 30, 2021.

(51) Int. Cl. B62H 3/04; B60R 9/10; B62J 9/21; B62J 11/00; B62J 23/00

(52) U.S. Cl. CPC B62H 3/04; B60R 9/10; B62J 9/21; B62J 11/00; B62J 23/00

(57) ABSTRACT

A rack adapter for bicycle fenders, including a tubular body having a first flange at a first end, and a second flange at a second, opposing end. A convex portion extends between the first and second flanges, the convex portion having an upper surface shaped to engage a wheel clamping member of a bicycle rack. The tubular body further includes a concave portion having a lower surface contoured to engage a wheel of a bicycle, and an inner passage defined between the convex portion and the concave portion. The inner passage extends through the tubular body from the first end to the second end and is configured to receive a fender of a bicycle.

### CROSS-REFERENCES

This application is a continuation of U.S. patent application Ser. No. 17/956,595 filed Sep. 29, 2022, which claims priority from U.S. Provisional Patent Application Ser. No. 63/250,458, filed Sep. 30, 2021. The complete disclosures of each application are hereby incorporated by reference in their entireties for all purposes.

### BACKGROUND

Many racks for transporting bicycles include a wheel clamp arm or hook. Often the front wheel, and sometimes the back are secured in place by hooking the arm over the wheel of the bicycle and tightening the clamp to secure and support the wheel. Unfortunately, such racks may not be compatible with bicycle fenders. The fender typically extends over the bicycle wheel to deflect mud, water and other debris when the bicycle is in use. However, the fender may interfere with the needed frictional contact between the clamp arm and wheel when the bicycle is carried on a rack. While technically removable, many fenders are not designed for frequent removal and reattachment, and can be prohibitively difficult or time-consuming to remove each time the bicycle is secured to a rack. An adapter is needed to allow such racks to easily and conveniently carry bicycles with fenders.

### SUMMARY

The present disclosure provides systems, apparatus, and methods relating to adapters for bicycle racks. In some examples, a bicycle rack adapter may include a tubular body. The tubular body may include a first flange at a first end, and a second flange at a second, opposing end. A convex portion may extend between the first and second flanges, the convex portion having an upper surface shaped to engage a wheel clamping member of a bicycle rack. The tubular body may further include a concave portion having a lower surface contoured to engage a wheel of a bicycle, and an inner passage defined between the convex portion and the concave portion. The inner passage may extend through the tubular body from the first end to the second end and may be configured to receive a fender of a bicycle.

In some examples, a bicycle rack adapter may include a first flange at a first end, and a second flange at a second, opposing end. A convex portion may extend between the first and second flanges, the convex portion having a plurality of raised ribs on an upper surface. The tubular body may further include a concave portion spaced from the convex portion and having a curved lower surface. The upper surface may have a geometry corresponding a bicycle rack wheel hook member, the lower surface may be curved in both lateral and longitudinal directions, and the concave portion may be sufficiently spaced from the convex portion to admit a bicycle wheel fender between the concave and convex portions.

In some examples, a bicycle secured to a rack may include a fender mounted to a frame component of the bicycle, the fender extending over a wheel of the bicycle, and an adapter. The adapter may include a first flange at a first end and a second flange at a second end, an upper surface extending between the first and second flanges, and a curved lower surface. An inner passage may extend through the adapter, and the fender may extend through the inner passage. A wheel hook member of the rack may be received between the first and second flanges, and contact the upper surface. The lower surface of the adapter may contact the wheel of the bicycle.

Features, functions, and advantages may be achieved independently in various examples of the present disclosure, or may be combined in yet other examples, further details of which can be seen with reference to the following description and drawings.

### BRIEF DESCRIPTION OF THE DRAWINGS

FIG. 1 is a schematic diagram of a cross section of an illustrative rack adapter in accordance with aspects of the present disclosure, taken along a lateral plane.

FIG. 2 is a schematic diagram of a cross section of the adapter of FIG. 1, taken along a longitudinal plane.

FIG. 3 is an isometric view of another illustrative rack adapter.

FIG. 4 is an isometric view of the adapter of FIG. 3, in use on a rack, to secure a bicycle having a fender.

FIG. 5 is a top plan view of the adapter of FIG. 3.

FIG. 6 is a side elevation view of the adapter of FIG. 3.

FIG. 7 is a front elevation view of the adapter of FIG. 3.

FIG. 8 is a cross-sectional view of the adapter of FIG. 3, as taken along line 8-8 in FIG. 4.

FIG. 9 is a cross-sectional view of the adapter of FIG. 3, as taken along line 9-9 in FIG. 4.

### DETAILED DESCRIPTION

Various aspects and examples of a rack adapter for bicycles having fenders, as well as related methods, are described below and illustrated in the associated drawings. Unless otherwise specified, an adapter in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; and (5) Conclusion.

### Definitions

The following definitions apply herein, unless otherwise indicated. Additionally, as used herein, like numerals refer to like parts.

“Substantially” means to be predominantly conforming to the particular dimension, range, shape, concept, or other aspect modified by the term, such that a feature or component need not conform exactly, so long as it is suitable for its intended purpose or function. For example, a “substantially cylindrical” object means that the object resembles a cylinder, but may have one or more deviations from a true cylinder.

“Approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of the specified value, insofar as such variations are appropriate to perform in the disclosure. It is to be understood that the value to which the modifier “approximately” refers is itself also specifically, and preferably, disclosed.

### Overview

In general, a rack adapter for bicycles having fenders may include upper and lower engaging surfaces. The adapter may be described as a having a central passage or aperture. The upper engaging surface may be shaped and/or otherwise configured to engage a wheel clamp arm of a bicycle rack, and the lower engaging surface may be shaped and/or otherwise configured to engage the wheel of a bicycle. When the bicycle is secured to the rack, the fender may extend through the central passage of the adapter. Force may be thereby transferred from the clamp arm through the adapter to the bicycle wheel without affecting or being impeded by the fender.

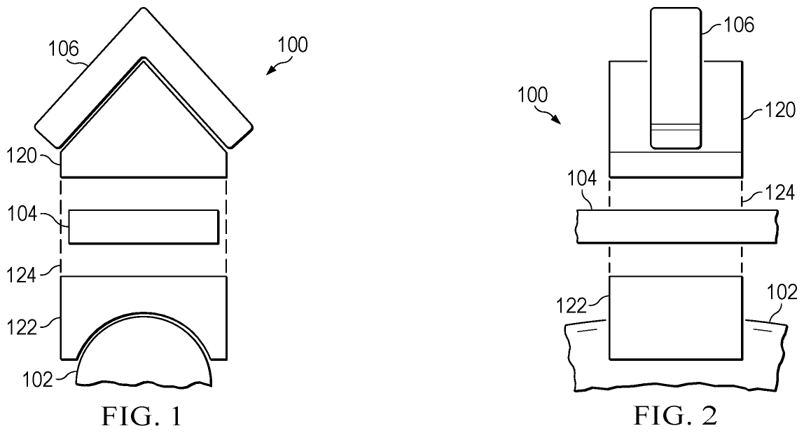

FIGS. 1 and 2 are schematic diagrams of an illustrative rack adapter 100, in cross section along lateral and longitudinal planes, respectively. In each of FIGS. 1 and 2, adapter 100 is depicted in use between a bicycle wheel 102 and a wheel retention device 106 of a bicycle rack. Adapter 100 is depicted spaced from wheel 102 and retention device 106 for visual clarity, but in use may contact each of the wheel and the retention device.

Adapter 100 includes a first portion 120, configured to engage wheel retention device 106 and a second portion configured to engage wheel 102. Due to the circular and thus convex shape of bicycle wheels, wheel retention devices on a majority of racks that include such a device have a concave contact surface to engage the wheel. Accordingly, first portion 120 of adapter 100 is convex to complement the contact or engaging surface of wheel retention device 106. Similarly, second portion 122 of the adapter is concave to complement wheel 102.

First portion 120 of adapter 100 is depicted as having a triangular shape to complement the depicted angled hook style of wheel retention device, but may have any shape appropriate to a selected retention device, rack, or range of racks. Wheel retention device 106 may include a ratchet hook, a strap, or another form of wheel clamping member(s).

In some examples, first portion 120 may include additional features to engage wheel retention device 106. For instance, the first portion may include flanges, and/or an engaging surface of the first portion may include ribs or a high grip material. For another instance, the first portion may further include fasteners, straps, or a cover to retain adapter 100 on the retention device. Preferably, any engagement features may be quick-release and/or manually operable.

Second portion 122 of adapter 100 is curved in first and second orthogonal directions, to match the curve of the tire of wheel 102. The second portion may contact the tire of the wheel, and be shaped to maximize frictional engagement on the tire and/or improve stability of the adapter on the tire. The second portion may be sized or shaped for a particular tire size and/or wheel size, or may be configured for use with a range of tires and/or wheels.

In some examples, second portion 122 may include additional features to engage wheel 102. For instance, an engaging surface of the second portion may include a high grip material. For another instance, the second portion may further include a ratchet strap extending around the rim of wheel 102. Preferably, any engagement features may be quick-release and/or manually operable.

A fender 104 of the bicycle extends between first portion 120 and second portion 122. Adapter 100 may be configured to transfer force between and/or mechanically link wheel retention device 106 and wheel 102, without engaging fender 104. Preferably, adapter 100 may not contact fender 104. For instance, downward force from a ratcheting hook may be applied to first portion 120, transferred through connecting structure 124 to second portion 122, and applied to wheel 102 by second portion 122 without any downward force applied to fender 104.

Adapter 100 further includes connecting structure 124, which connects first portion 120 and second portion 122 without obstructing fender 104. In some examples, first portion 120, second portion 122, and connection structure 124 may form a single unitary structure. For instance, adapter 100 may be a tubular body made as a single molded piece of plastic. In some examples, structure 124 may be separate from the first and second portions and/or comprised of a different material. For instance, connecting structure 124 may comprise a plurality of aluminum rods extending between first and second portions comprised of silicone.

In some examples, adapter 100 may be rigid and/or have a fixed geometry. In some examples, the adapter may include expandable, telescoping, flexible, or otherwise dynamic elements. For instance, second portion 122 may expand laterally to accommodate wider bicycle tires. For another example, connecting structure 124 may telescope vertically to accommodate a thicker or unusually shaped fender.

Adapter 100 may include features for engagement with other elements of the bicycle and/or the rack. For example, first portion 120 may include a slot or cut-out to avoid a headlight or other accessory secured to the steering tube of the bicycle. For another example, the adapter may include a compressible material at an end adjacent the bicycle frame to avoid damaging the front fork or other frame members of the bicycle by contact with the adapter.

### Examples, Components, and Alternatives

The following sections describe selected aspects of exemplary bicycle rack adapters as well as related systems and/or methods. The examples in these sections are intended for illustration and should not be interpreted as limiting the entire scope of the present disclosure. Each section may include one or more distinct examples, and/or contextual or related information, function, and/or structure.

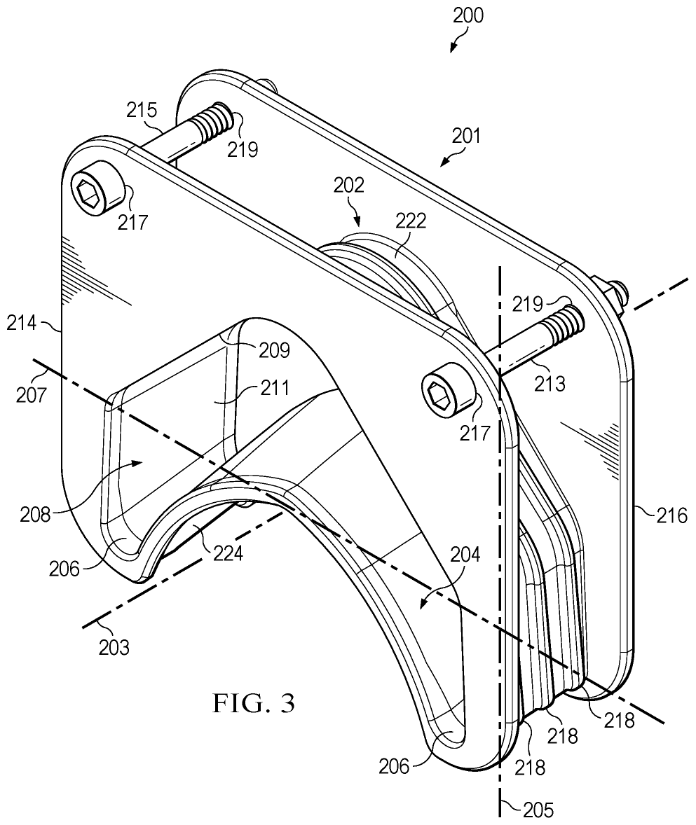

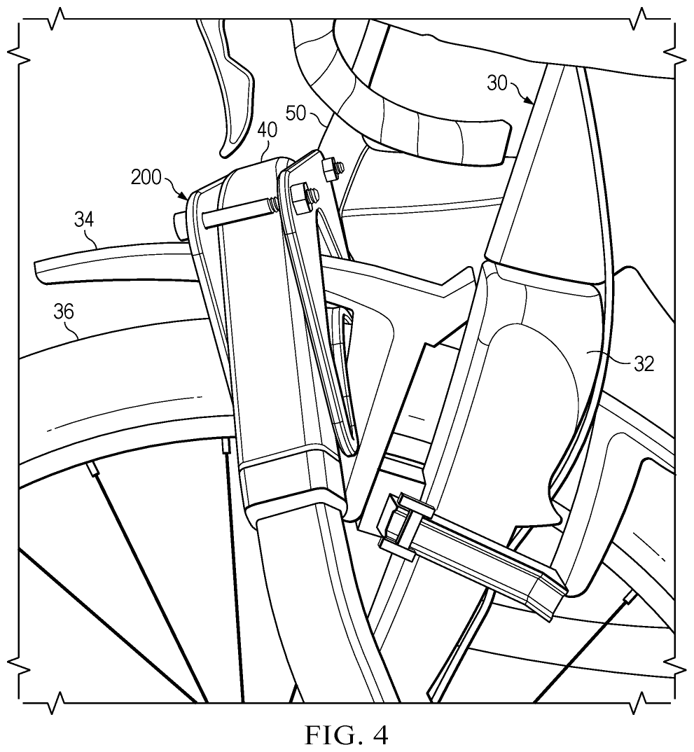

As shown in FIGS. 3-9, this section describes an illustrative rack adapter 200. Adapter 200 is an example of a rack adapter for bicycles having fenders, as described above. Adapter 200 is a single unitary tubular body 201, comprised of a rigid molded plastic.

Referring first to FIG. 3, body 201 includes a convex upper portion 202 and a concave lower portion 204. An upper surface 222 of convex portion 204 is shaped to conform to a bicycle rack wheel hook. A lower surface 224 of concave portion 204 is shaped to conform to the tire of a bicycle wheel. The convex and concave portions meet and are joined along two edges or corners 206. An inner passage 208 is defined between convex portion 202 and concave portion 204, and extends through the adapter. The inner passage may also be described as an aperture, channel, or central opening. Inner passage 208 is sized to receive, admit, or pass a bicycle fender. Preferably the passage may be of sufficient size and appropriate shape to allow the fender to extend through without contacting the adapter.

Adapter 200 may be described as having a longitudinal axis 203, a vertical axis 205, and a lateral axis 207. The adapter may also be described as having a longitudinal extent, a height, and a lateral extent. Adapter 200 may be described as laterally symmetrical, but longitudinally asymmetrical. That is, the adapter may be described as having matching left and right sides, but having a front end 210 different from a back end 212. Passage 208 extends continuously through adapter 200 from front end 210 to back end 212.

When in use on a rack to secure a bicycle, longitudinal axis 203 may be substantially parallel a long axis or travel axis of the bicycle, lateral axis 207 of the adapter may be substantially parallel a lateral or left-to-right axis of the bicycle, and vertical axis 205 may be substantially parallel a vertical axis of the bicycle. It may be understood that the axes of the bicycle may differ from axes of the rack or a vehicle to which the rack is mounted. If the bicycle is secured at an angle, the vertical axis of the bicycle and the adapter may differ from a gravitational direction, for example.

Orientations and positions of the adapter and elements thereof are described herein relative to axes 203, 205, 207 of the adapter. For instance, descriptions herein related to position including terms such as “upper”, “lower”, “above”, “below”, “in front of” or “behind” may be understood in the frame of reference of the adapter and the depicted axes.

In the depicted example, convex portion 202 may be described as made up of four approximately planar wall sections meeting at curved corners. Two upper walls 209 meet in the middle to define upper surface 222. Two side walls 211 extend down approximately vertically from the upper walls to connect to corners 206. Convex portion 202 has lateral symmetry, and is primarily longitudinally symmetrical, apart from the ribs as described below.

In the depicted example, convex portion 202 may be described as having a curved triangular shape, matching a substantially triangular wheel hook. In some examples, the convex portion may have a curved upper surface to match a curved hook, or may have any shape appropriate to engage a wheel clamp member.

Convex portion 202 includes a flange or lip at each end. That is, the convex portion includes a first flange 214 at front end 210 and a second flange 216 at back end 212. Each flange extends along the edge of convex portion 202, ending at corners 206. In the depicted example, each flange 214, 216 extends approximately perpendicular to upper surface 222 of the convex portion. In some examples, one or more flanges may extend at other angles. For instance, the flanges may angle out away from upper surface 222.

The flanges may retain a wheel hook in engagement on convex portion 202, and may be sufficiently strong and of sufficient extent to impede a wheel hook and prevent the hook sliding off of either end of the adapter. The flanges may also provide structural reinforcement to the adapter body, so that the wheel hook can exert sufficient force on the adapter without deforming or damaging the adapter.

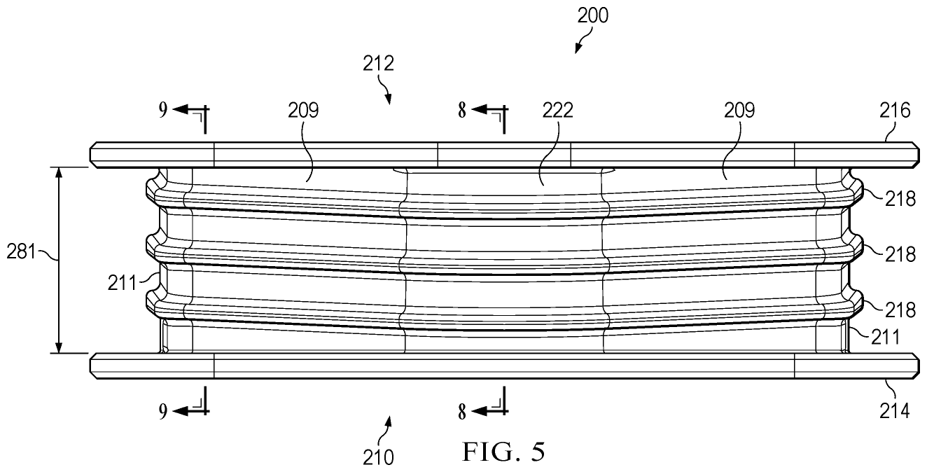

In the depicted example, adapter 200 is configured for a specific bicycle rack. That is, the adapter is shaped and sized to closely conform to the wheel hook of that rack, as discussed further with reference to FIGS. 5, and 7-9, below. For example, adapter 200 has a limited longitudinal extent, approximately matching that of the wheel hook. The flanges may contact both sides of the wheel hook, when engaging the adapter, and the adapter may be described as ‘press-fit’ on the wheel hook.

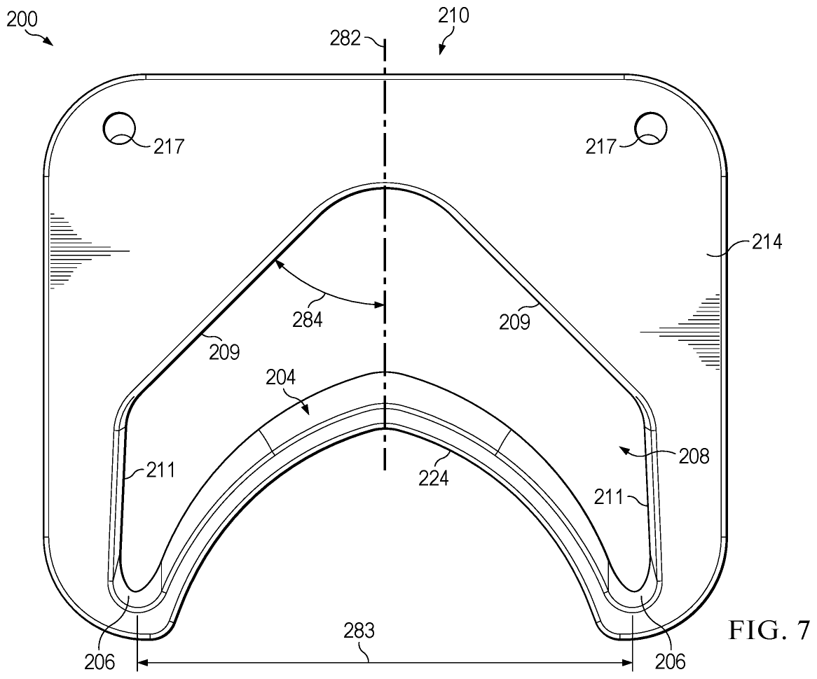

In the depicted example, convex portion 202 further includes a plurality of ridges or ribs 218 projecting from the engaging surface of the convex portion. The ribs extend parallel flanges 214, 216 over upper walls 209 of the convex portion, and down side walls 211 at an oblique angle to the flanges, as described further with reference to FIGS. 5 and 7, below. The ribs may improve grip or frictional engagement between the wheel hook and convex portion 202, and may also add to the structural strength of the adapter.

In some examples, convex portion 202 may additionally or alternatively include other structure or materials appropriate to improve grip, such as a pattern of raised rounded bosses or a silicone covering. In some examples, convex portion 202 and/or any portion of adapter 200 may include ribs, flanges, cut-outs, or any structural features effective in improving strength and durability of the adapter and/or reducing material needed for a desired level of strength.

In the depicted example, adapter 200 further includes a right bolt 213 and a left bolt 215, which each extend through a pair of corresponding apertures in flanges 214, 216 to engage a nut at the back end of the adapter. First flange 214 includes a pair of holes 217 positioned at opposing lateral ends of the first flange. Second flange 216 includes a pair of holes 219 in corresponding positions in the second flange.

Right bolt 213 extends through a right one of holes 217 in first flange 214, and engages the threads of the corresponding right one of holes 219 in second flange 216. Similarly, left bolt 215 extends through a left one of holes 217 in the first flange and engages the threads of the corresponding left one of holes 219 in the second flange.

In some examples, adapter 200 may include other types of fastener in addition to or in place of bolts 213, 215. The adaptor may include any number, type, and/or position of fastener which is effective to affix the adaptor to the wheel hook or other wheel clamping member. For example, the fastener or fasteners may include one or more bolts, pins, and/or clips. Affixing the adapter in such a manner may provide added stability during use of the rack and the adapter.

In an example, the adapter may include a pair of detent pins or quick release pins, each having a jump ring for easy manual removal and installation. In some examples, bolts 213, 215 may include a textured knob or other feature to facilitate manual removal and installation of the bolts. In some examples, one or both pairs of holes 217, 219 in flanges 214 and/or 216 may be threaded to engage the threading of each bolt in place of or in addition to a nut.

When a wheel hook engages convex portion 202, bolts 213, 215 may extend over the wheel hook. As a result the wheel hook may be trapped relative to adapter 200 along all three axes. That is, the wheel hook may be trapped between bolts 213, 215 and upper surface 222 of the convex portion, and thereby prevented from moving vertically. The wheel hook may be prevented from moving laterally by geometric engagement of the hook shape and the complementary convex portion, and may be prevented from moving longitudinally by flanges 214, 216.

Flanges 214, 216 and bolts 213, 215 are configured to retain adapter 200 on the wheel hook, and/or attach the adapter to the rack. Adapter 200 may be temporarily attached to the wheel hook of the bicycle rack, or may be installed on an extended basis. For example, a user owning the rack and a bicycle with a fender may leave the adapter installed indefinitely, for repeated use with the bicycle.

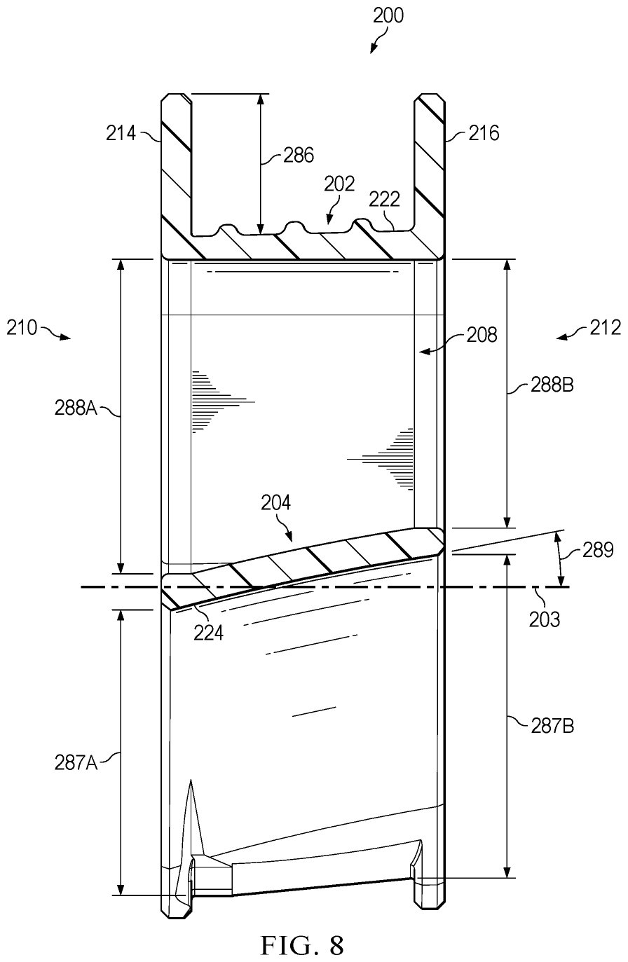

Concave portion 204 is curved both laterally and longitudinally, to complement the curvature of a bicycle wheel. The lateral curve is depicted in FIG. 7, and the longitudinal curve is depicted in FIG. 8. Such curvature may maximize contact and frictional engagement between the tire of the bicycle wheel and a lower engaging surface 224 of concave portion 204. The radius of curvature of each curve, and the lateral extent of engaging surface 224 may be selected to accommodate a variety of bicycle wheels. That is, a greater lateral radius of curvature and extent may allow wider tires such as those on mountain bikes as well as the slimmer tires of road bikes. A greater longitudinal radius of curvature may also allow larger wheel radii.

Concave portion 204 may be described as having an arched, or gothic arch shape. Such shape may provide effective engagement with a range of bicycle tire sizes, as described further with reference to FIG. 7, below.

In the depicted example, concave portion 204 has a longitudinal extent matching convex portion 202. In some examples, the concave portion may include a tab or protrusion at a front and/or back end, to longitudinally extend the concave portion past the convex portion. Such tabs may increase the surface area of the lower engaging surface, improving grip or frictional engagement between the adapter and the bicycle wheel.

FIG. 4 depicts adapter 200 in use, allowing a bike 30 to be secured to a vehicle 50 for transport, using a bicycle rack with a wheel hook 40. The back end of adapter 200 is depicted spaced from a front wheel fork 32, but may also be used abutting the front wheel fork, as appropriate to geometry of the individual bicycle. The concave portion of adapter 200 is resting on the tire of a wheel 36, with a front fender 34 extending through the inner passage. Hook 40 is positioned overtop the convex portion, between the front and back flanges.

Adapter 200 may be described as providing a load path which bypasses fender 34. That is, the upper surface of the adapter serves as a loading surface for wheel hook 40 to press down on, transferring the applied force around fender 34 to the tire of wheel 36. The clamping force of the wheel hook may thereby secure the wheel without deforming or damaging the fender.

To secure bike 30 to the rack, the user may first place the bike on the rack tray or other support. Next, the user may position adapter 200 by sliding the adapter over fender 34 up to front fork 32, such that the fender extends through the inner passage of the adapter. The user may then rest adapter 200 on wheel 36, such that the lower engaging surface of the adapter contacts the tire.

Once adapter 200 is positioned on bike 30, the user may remove the bolts from the adapter. Wheel hook 40 may then be used to secure wheel 36 per rack instructions, but with the wheel hook positioned on the convex portion of the adapter rather than directly on the bike wheel. Finally, the bolts may be replaced in adapter 200, to retain wheel hook 40 between the flanges of the adapter.

Alternatively, the user may install adapter 200 on wheel hook and then secure bike 30 on the rack. That is, the user may remove the bolts from adapter 200 and position the adapter on wheel hook 40 such that the hook is received between the flanges and contacts the convex surface. The user may then replace the bolts in adapter 200. The wheel hook may be positioned on wheel 36 such that fender 34 extends through the inner passage of adapter 200, and then tightened or secured. In such examples, the user may opt to leave adapter 200 secured to the rack when the rack is not in use, or to remove the adapter between uses.

Adapter 200 may additionally or alternatively include other features. For example, the adapter may be configured for use with a range of racks. In such an example, the upper surface of the convex portion, the loading surface where the wheel clamping member makes contact, may be oversized to allow compatibility with a variety of hook sizes, shapes and/or clamping member types.

In some examples the upper surface may further include an upwardly protruding triangular or wedge-shaped stop. A wheel hook or other clamp member engaging the adapter may rest against the stop. In some examples the convex portion may include a recess configured to accommodate accessories fixed to the bike fork or head tube.

In some examples, the adapter may be configured for use on a rear fender. In such examples, the adapter may rest against the tire and the rear fork, seat stay, or seat post of the bike, or a structural support of the rear fender. The adapter may be reversible and/or longitudinally symmetric and appropriate for use on either a front or rear fender.

In some examples, the adapter may be configured according to shape and/or structural properties of a particular model, line, or brand of bicycle or fender. In some examples, the adapter may be configured for compatibility with a specific bicycle rack.

FIG. 5 is a top view of adapter 200, showing upper walls 209 and upper surface 222 of convex portion 202. As shown, the adapter is laterally symmetrical about a center line. Each of an overall longitudinal extent of the adapter and an inner longitudinal span 281 are approximately constant across the adapter. Inner longitudinal span 281 may also be described as a longitudinal extent of upper surface 222.

In the depicted example, the plurality of raised ribs includes three ribs 218. Ribs 218 are approximately equally spaced from one another and from flanges 214, 216. In general, the adapter may include an appropriate number of ribs. The number, size, and/or spacing of ribs 218 may depend on inner longitudinal span 281, which may in turn be determined by the rack or racks for which adapter 200 is configured. In the depicted example, adapter 200 is sized to closely conform to a wheel hook. In other examples, the adapter may have a greater span to accommodate larger hooks, or a range of clamp member sizes.

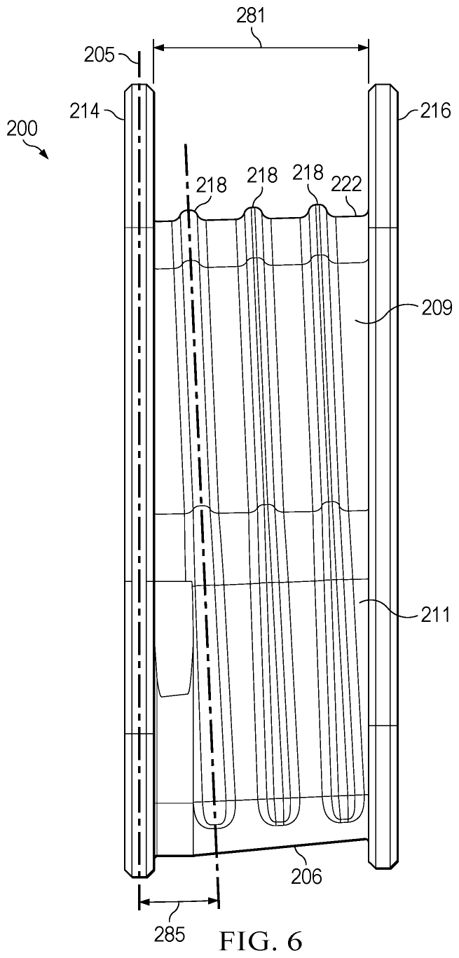

Over upper walls 209, each rib 218 extends parallel the other ribs, parallel the plane of flanges 214, 216, and the plane defined by the lateral axis and the vertical axis of the adapter. As described further with reference to FIG. 6, ribs 218 deviate from the plane of flanges 214, 216 as the ribs extend down side walls 211.

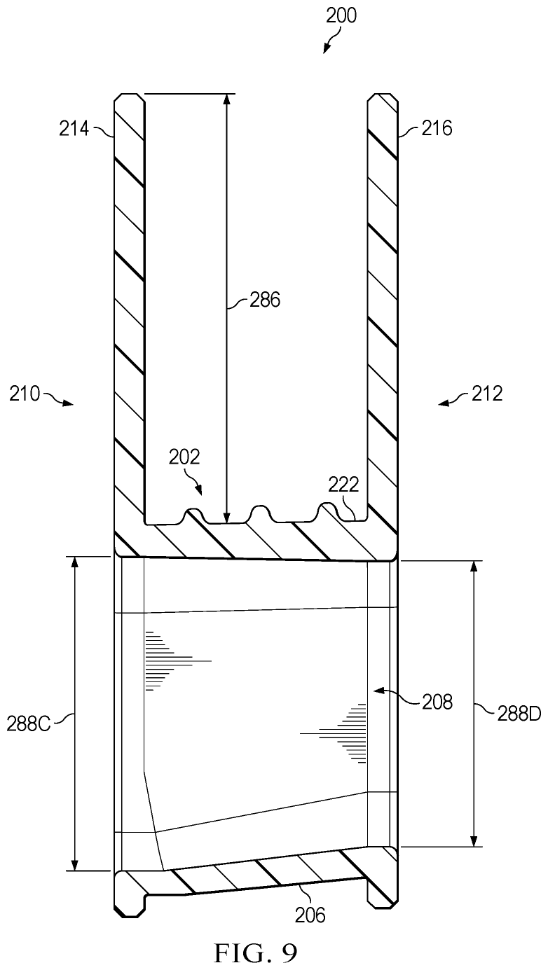

Flanges 214, 216 have a greater lateral extent than convex portion 202. That is, each flange extends beyond convex portion 202 to left and right. The flanges may also be described as extending out substantially perpendicularly to side walls 211 of the convex portion. A lateral extent of flanges 214, 216 beyond convex portion 202 may be less than a vertical extent of the flanges beyond the convex portion, as described further with reference to FIGS. 8 and 9, below.

The top portion of the flanges may be primarily responsible for longitudinally restraining motion of a wheel hook, to aid in retaining the hook on the adapter. The side portion of the flanges may provide auxiliary restraint and/or improve structural properties of the adapter. An overall lateral extent of adapter 200, including flanges 214, 216 may be limited to avoid interference with a side arm portion of a wheel hook, or other side elements of wheel clamp members.

FIG. 6 is a side view of adapter 200, showing a right-hand one of both upper walls 209 and side walls 211 of convex portion 202. The left-hand side of the adapter may be understood to match. Each of an overall longitudinal extent of the adapter and inner longitudinal span 281 are approximately constant down the adapter. The adapter has the same longitudinal extent at top and bottom.

Unlike on upper walls 209, ribs 218 do not extend parallel flanges 214, 216 down side walls 211. Instead, ribs 218 extend at an oblique angle 285 relative to vertical axis 205. In the depicted example, angle 285 is approximately 2-3 degrees. Angle 285 may be selected according to the shape and placement of a rack's wheel hook. That is, ribs 218 may be configured to extend approximately parallel an arm of the wheel hook, in order to facilitate grip by the wheel hook. In examples where a rack includes another type of wheel clamp member, the ribs may have a correspondingly different extent, orientation, and/or shape.

FIG. 7 is an elevation view of front end 210 of adapter 200. Passage 208 can be seen to extend fully through adapter 200 without obstruction. The passage is defined between convex portion 202 and concave portion 204, with a generally pentagonal shape. That is, upper walls 209 and side walls 211 of convex portion 202 form four sides of passage 208, with concave portion 204 forming a fifth, curved side.

Upper walls 209 extend at an oblique angle relative to the vertical. That is, upper walls 209 are substantially planar, extending approximately perpendicular to lateral axis 207, approximately parallel to longitudinal axis 203, and at an oblique angle to vertical axis 205 (see FIG. 3). As shown in FIG. 7, upper walls 209 form an angle 284 with a vertical central line 282. Angle 284 may correspond to and/or be selected according to an angle of a wheel hook. In the depicted example, angle 284 is approximately 45 degrees.

In the depicted example, convex portion 202 and concave portion 204 have approximately consistent thickness apart from ribs 218 (FIG. 3). Consequently, the inner surface shape of each substantially matches the outside surface shape, and the shape of passage 208 corresponds to the shapes of the upper and lower surfaces of the convex and concave portions, respectively. Such consistent thickness and corresponding shape may provide a passage sufficiently sized to receive a bicycle fender, while also minimizing material needed to produce adapter 200.

In some examples, passage 208 may have a different shape from convex portion 202 and/or concave portion 204. However, the passage may at least be of sufficient size and appropriate shape to receive a bicycle fender. Preferably, the passage may be sufficiently sized to provide clearance around the fender, and avoid contact between the fender and the adapter during use. In the depicted example, passage 208 has smooth sides, but in some examples one or more sides of the passage may include reinforcing ribs, textures, or other protrusions.

Unlike passage 208, in the depicted example flanges 214, 216 vary in extent and therefore deviate from the shape of convex portion 202. More specifically, flange 214, and flange 216 not shown in FIG. 7, have a substantially rectangular outer edge. That is, each flange has three flat sides meeting at two rounded corners. Two of the flat sides are vertical, and are joined by the third, which is lateral. One of holes 217, 219 is positioned proximate each rounded corner. In general, the shape of the flanges may be selected to effectively engage a wheel hook or other clamp member and/or to position fasteners as appropriate to secure the clamp member. Flanges 214, 216 may follow the shape of convex portion 202, or differ.

Lateral symmetry of adapter 200, and in particular concave portion 204 is also depicted in FIG. 7. That is, concave portion 204 is symmetric about center line 282. The concave portion may be described as having a lateral curve comprising first and second mirrored curves meeting at the center line. The lateral curve may be described as pointed, non-circular, or gothic arch shaped.

Concave portion 204 is laterally curved from a first one of corners 206 to the second of the corners. The concave portion also has a consistent lateral width 283 from corner to corner, throughout the longitudinal extent of adapter 200. However, a height of the lateral curve varies non-linearly along the longitudinal extent, as discussed with reference to FIG. 8, below. That is, concave portion 204 is curved both laterally and longitudinally.

Lateral width 283 may be selected according to a bicycle tire size, or range of tire sizes. In the depicted example, adapter 200 is configured to engage both narrow road tires and wide mountain bike tires. That is, lower surface 224 of concave portion 204 both receives and makes significant frictional contact with tires between approximately 23 to 75 millimeters (0.9 to 3 inches) in diameter. Lateral width 283 is sufficient to receive up to approximately a 3 inch tire, while lower surface 224 is shaped to ensure sufficient contact with smaller tires. The pointed curve shape may contact the rounded curve of a tire at two separate points, for good frictional engagement, even when the tire diameter is significantly smaller than lateral width 283.

FIG. 8 is a cross-sectional view of adapter 200, taken along line 8-8 in FIG. 3, or vertically along the center line of the adapter. FIG. 9 is another cross-sectional view, also taken vertically but at the lateral position of the left-hand corner 206, along line 9-9 in FIG. 3.

As can be seen in both FIGS. 8 and 9, flanges 214, 216 have a greater vertical extent than convex portion 202. That is, each flange extends up beyond convex portion 202. However, a vertical extent 286 of flanges 214, 216 beyond convex portion 202 varies laterally along the adapter. Vertical extent 286 is significantly greater over corner 206 than at the center line of the adapter. Between the depicted positions, vertical extent 286 varies by more than three hundred percent.

Flanges 214, 216 may be described as extending out substantially perpendicularly to upper surface 222 of the convex portion. Vertical extent 286 may also be described as a depth or a length of the flanges. The variation of the flange depth may depend on the differences in shape between convex portion 202 and the outer edges of the flanges. In some examples, flanges 214, 216 may have a consistent, unvarying extent.

In FIG. 8, the longitudinal curve of concave portion 204 is shown. The radius of curvature of the longitudinal curve may be selected according to an expected range of wheel radii. For example, the radius of curvature may be approximately 350 millimeters (13.75 inches) to accommodate standard adult bicycle wheels of 660 to 735 millimeters (26 to 29 inches) diameter.

The longitudinal curve of concave portion 204 is asymmetrical. In the depicted example, the curve may be described as a circle section corresponding to approximately the range of 95 to 105 degrees. In some examples, the curve may correspond to a circle section extending 20 or 30 degrees, or more. Preferably, the curve may correspond to a circle section in the second quadrant of the unit circle, or extend in the range between 90 and 180 degrees. In other words, the concave portion 204 may curve like a top left portion of a circle, not the symmetrical top portion of the circle.

As the longitudinal radius of curvature of concave portion 204 is large relative to the longitudinal extent of the concave portion, the concave portion may also be described as approximately slanted. The concave portion may be described as slanting up from front end 210 to back end 212 of the adapter. A general longitudinal extent of concave portion 204 may form an angle 289 with longitudinal axis 203 at any given lateral position. In FIG. 8, angle 289 is approximately 10 degrees. In the depicted example, corner 206 is also slanted upward front the front end to the back end of the adapter. Corner 206 may have the same slant angle as concave portion 204, or may differ in angle.

Due to the longitudinal asymmetry of concave portion 204, a height of passage 208 varies from front end 210 to back end 212 of adapter 200. The height of the passage also varies laterally. As depicted in FIGS. 8 and 9, a height 288 of passage 208 has four different values: 288A at the front end and center of the adapter, 288B at the back end and center of the adapter, 288C at the front end and over the corner, and 288D at the back end and over the corner. Height 288 is greater at the front end of the adapter than at the back end of the adapter, at every lateral position, due to the asymmetry of concave portion 204. Specifically, 288A is greater than 288B and 288C is greater than 288D.

Concave portion 204 may also be described as having a height 287. Height 287 is greatest at 287B in FIG. 8, at the peak of the lateral curve of the concave portion and at back end 212. Height 288B is greater than 288A, also at the peak of the lateral curve of the concave portion, but at front end 210. In other words, the height of the lateral curve of concave portion 204 increases from front end 210 to back end 212.

### Illustrative Combinations and Additional Examples

This section describes additional aspects and features of rack adapters for bicycles having fenders, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. A bicycle rack adapter, comprising:
a tubular body including,
   a convex upper portion configured to engage a wheel clamping member of a bicycle rack,
   a concave lower portion configured to contact a wheel of a bicycle, and
   an inner passage defined between the upper portion and the lower portion, configured to receive a fender of the bicycle.
A1. The adapter of A0, wherein the convex upper portion has a flange at each of first and second opposing ends.
A2. The adapter of A1, wherein the flanges of the first and second ends extend approximately perpendicular to an engaging surface of the convex upper portion.
A3. The adapter of A1 or A2, wherein the flanges of the first and second ends extend approximately radially outward relative the center of the bicycle wheel when the concave lower portion contacts the wheel of the bicycle.
A4. The adapter of any of A1-A3, wherein the concave lower portion includes tabs extending beyond the first and second ends of the convex upper portion.
A5. The adapter of any of A0-A4, wherein the tubular body is rigid.
A6. The adapter of any of A0-A5, wherein the tubular body is unitary.
A7. The adapter of any of A0-A6, wherein the convex upper portion has an engaging surface with a plurality of raised ribs.
A8. The adapter of any of A0-A7, wherein the convex portion includes a recess configured to receive an accessory mounted to a fork of the bicycle.
A9. The adapter of any of A0-A8, wherein the concave lower portion is curved to complement and conform to the bicycle wheel.
A10. The adapter of A9, wherein the concave lower portion is curved in both lateral and longitudinal directions.
A11. The adapter of any of A0-A10, wherein the concave lower portion is sized to accommodate a range of bicycle tire widths.
A12. The adapter of A11, wherein the range of bicycle tire widths is between 0.5 and 3 inches.
A13. The adapter of any of A0-A12, wherein the convex upper portion has a substantially triangular cross-sectional shape.
A14. The adapter of any of A0-A13, wherein the convex upper portion is shaped to complement and conform to the wheel clamping member of a specific type of bicycle rack.
A15. The adapter of any of A0-A14, wherein the concave lower portion extends through a greater arcuate range than the convex upper portion.
A16. The adapter of any of A0-A15, wherein the adapter comprises a plastic material.
A17. The adapter of any of A0-A16, wherein the adapter does not contact the fender when the fender is received in the inner passage.
B0. A bicycle, comprising:
a fender mounted to a frame component and extending over a wheel, and
an adapter including,
   a first flange at a first end and a second flange at a second end,
   an upper surface extending between the first and second flanges and configured to frictionally engage a wheel clamping hook member,
   a curved lower surface, and
   an inner passage extending through the adapter,
wherein the fender extends through inner passage, and the lower surface contacts the wheel.
C0. A method of securing a bicycle to a rack, comprising:
sliding a fender of the bicycle through an inner passage of an adapter,
contacting a curved lower surface of the adapter with a wheel of the bicycle, hooking a wheel clamping member of the rack over an upper surface of the adapter,
tightening the wheel clamping member to secure the wheel of the bicycle to the rack.
C1. The method of C0, further including securing the adapter to the wheel clamping member.
D0. An adapter for accommodating a bicycle fender, comprising:
a rigid sleeve having an opening for receiving a fender, the sleeve having an upper surface configured to contact an arm portion of a bicycle rack, and a lower surface configured to contact a surface of a tire.
E0. A bicycle rack adapter, comprising:
a tubular body including:
   a first flange at first end and a second flange at a second, opposing end,
   a convex portion extending between the first and second flanges, having an upper surface shaped to engage a wheel clamping member of a bicycle rack,
   a concave portion having a lower surface contoured to engage a wheel of a bicycle, and
   an inner passage defined between the convex portion and the concave portion, extending through the tubular body from the first end to the second end and configured to receive a fender of the bicycle.
E1. The adapter of E0, wherein the first and second flanges extend approximately perpendicular to the upper surface of the convex portion.
E2. The adapter of E0 or E1, wherein the tubular body is rigid and unitary.
E3. The adapter of any of E0-E2, wherein the upper surface of the convex portion includes a plurality of raised ribs.
E4. The adapter of E3, wherein the convex portion includes first and second side walls, the side walls being connected to the concave portion and the plurality of raised ribs extending from the upper surface over the first and second side walls.
E5. The adapter of E3 or E4, wherein the plurality of raised ribs are parallel one another, but extend at an oblique angle relative to the first and second flanges.
E6. The adapter of any of E0-E5, wherein each of the flanges includes an aperture, and further including a fastener extending through both apertures.
E7. The adapter of any of E0-E6, wherein the concave portion is curved in both lateral and longitudinal directions.
E8. The adapter of E7, wherein a lateral width and the lateral curvature of the concave portion are sized to receive and engage bicycle tires as wide as 3 inches and as narrow as 0.5 inches.
E9. The adapter of any of E0-E8, wherein the convex portion has a rounded triangular shape and the concave portion has a gothic arch shape.
E10. The adapter of any of E0-E9, wherein the adapter does not contact the fender when the fender is received in the inner passage.
E11. The adapter of any of E0-E10, wherein the wheel clamping member contacts the first flange and the second flange when engaging the upper surface of the convex portion.
E12. The adapter of any of E0-E11, wherein the concave portion slants upward from the first end to the second end.
F0. A bicycle rack adapter, comprising:
a first flange at a first end and a second flange at a second end,
a convex portion extending between the first and second flanges and including a plurality of raised ribs on an upper surface, and
a concave portion spaced from the convex portion and having a curved lower surface,
wherein the upper surface has a geometry corresponding to a bicycle rack wheel hook member, the lower surface is curved in both lateral and longitudinal directions, and the concave portion is sufficiently spaced from the convex portion to admit a bicycle wheel fender between the concave and convex portions.
G0. A bicycle secured to a rack, comprising:
a fender mounted to a frame component of the bicycle and extending over a wheel of the bicycle, and
an adapter including,
   a first flange at a first end and a second flange at a second end,
   an upper surface extending between the first and second flanges,
   a curved lower surface, and
   an inner passage extending through the adapter,
wherein the fender extends through the inner passage, a wheel hook member of the rack is received between the first and second flanges and contacts the upper surface, and the lower surface contacts the wheel.
G1. The bicycle of G0, wherein the adapter includes a pair of fasteners, each extending between the first flange and the second flange, the fasteners extending over the wheel hook member received between the first and second flanges.
G2. The bicycle of G0 or G1, wherein the upper surface includes a plurality of raised ribs.
G3. The bicycle of G2, wherein the plurality of raised ribs are approximately parallel an extent of the wheel hook member.
G4. The bicycle of any of G0-G3, wherein the adapter does not contact the fender.
G5. The bicycle of any of G0-G4, wherein the wheel hook member contacts the first flange and the second flange.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A bicycle rack adapter, comprising:
a tubular body including:
a first flange at a first end and a second flange at a second, opposing end,
a convex portion extending between the first and second flanges, having an upper surface shaped to engage a wheel clamping member of a bicycle rack,
a concave portion having a lower surface contoured to engage a wheel of a bicycle, and
an inner passage defined between the convex portion and the concave portion, extending through the tubular body from the first end to the second end and configured to receive a fender of the bicycle.
